(19) United States
(12) Patent Application Publication
(10) Pub. No.: US 2017/0053359 A1
(43) Pub. Date: Feb. 23, 2017

(54) FARM-WORK-DETAIL INPUT SUPPORT METHOD, RECORDING MEDIUM, AND INPUT SUPPORT APPARATUS

(71) Applicant: FUJITSU LIMITED, Kawasaki-shi (JP)

(72) Inventors: Naoki Sakiyama, Setagaya (JP); Daisuke Kawai, Saitama (JP); Makoto Honda, Odawara (JP)

(21) Appl. No.: 15/294,197

(22) Filed: Oct. 14, 2016

Related U.S. Application Data
(63) Continuation of application No. PCT/JP2014/061333, filed on Apr. 22, 2014.

(51) Int. Cl. G06Q 50/02; G06Q 10/06

(52) U.S. Cl. CPC G06Q 50/02; G06Q 10/06314

(57) ABSTRACT

A farm-work-detail input support method includes receiving, by a computer, selection of a field, selection of a work item, and designation of a total work time; and recording and distributing, by the computer, the total work time when multiple fields and multiple work items are selected, all the selected work items being assigned to all the selected fields and the total work time being distributed to each work item in each field.

### CROSS REFERENCE TO RELATED APPLICATIONS

This application is a continuation application of International Application PCT/JP2014/061333 filed on Apr. 22, 2014 and designating the U.S., the entire contents of which are incorporated herein by reference.

### FIELD

The embodiments discussed herein relate to a farm-work-detail input support method, a recording medium, and an input support apparatus.

### BACKGROUND

In the agricultural industry, it is often difficult for a worker to operate an information processing terminal in the field to input work results. Therefore, the worker often works in several fields and during a break or when having finished working, returns to the office and collectively inputs work results for various work items with respect to the fields in which the work was performed.

According to a related technique, for example, a support item table is referred to and from the total time consumed for a caregiver to perform all support, the actual support time consumed for the caregiver to perform each support item is obtained by performing division proportionately. For example, refer to Japanese Laid-Open Patent Publication No. H11-306242.

### SUMMARY

According to an aspect of an embodiment, a farm-work-detail input support method includes receiving, by a computer, selection of a field, selection of a work item, and designation of a total work time; and recording and distributing, by the computer, the total work time when multiple fields and multiple work items are selected, all the selected work items being assigned to all the selected fields and the total work time being distributed to each work item in each field.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting one example of a farm-work-detail input support method according to an embodiment;

FIG. 2 is a diagram depicting an example of system configuration of a farming support system 200;

FIG. 3 is a block diagram depicting an example of hardware configuration of an input support apparatus 100;

FIG. 4 is a block diagram depicting an example of hardware configuration of a client apparatus 201;

FIG. 5 is a diagram depicting an example of the contents of a production plan DB 220;

FIG. 6 is a diagram depicting an example of the contents of an agrochemical master 230;

FIG. 7 is a diagram depicting an example of the contents of a work detail table 240;

FIG. 8 is a diagram depicting a detailed example of agrochemical application detail information;

FIG. 9 is a diagram depicting an example of a work recording screen (part 1);

FIG. 10 is a diagram depicting an example of a field selection screen;

FIG. 11 is a diagram depicting an example of a work item selection screen;

FIG. 12 is a diagram depicting an example of a worker selection screen;

FIG. 13 is a diagram depicting an example of the work recording screen (part 2);

FIG. 14 is a block diagram of an example of a functional configuration of the input support apparatus 100;

FIG. 15 is a diagram depicting an example of a work time screen;

FIG. 16 is a diagram depicting an example of transition of the stored contents of the work detail table 240;

FIG. 17 is a diagram depicting an example of an agrochemical selection screen;

FIG. 18 is a diagram depicting an example of an application detail input screen;

FIG. 19 is a diagram depicting an example of a farm-field application detail display screen;

FIG. 20 is a diagram depicting an example of selection of an input method for an application amount of an agrochemical;

FIGS. 21 and 22 are flowcharts depicting an example of a procedure of an input support process of the input support apparatus 100;

FIG. 23 is a flowchart depicting an example of a procedure of a work time updating process of the input support apparatus 100; and

FIG. 24 is a flowchart depicting an example of an agrochemical application amount updating process of the input support apparatus 100.

### DESCRIPTION OF THE INVENTION

Embodiments of a farm-work-detail input support method, a farm work detail input support program, and an input support apparatus of the present invention will be described in detail with reference to the accompanying drawings.

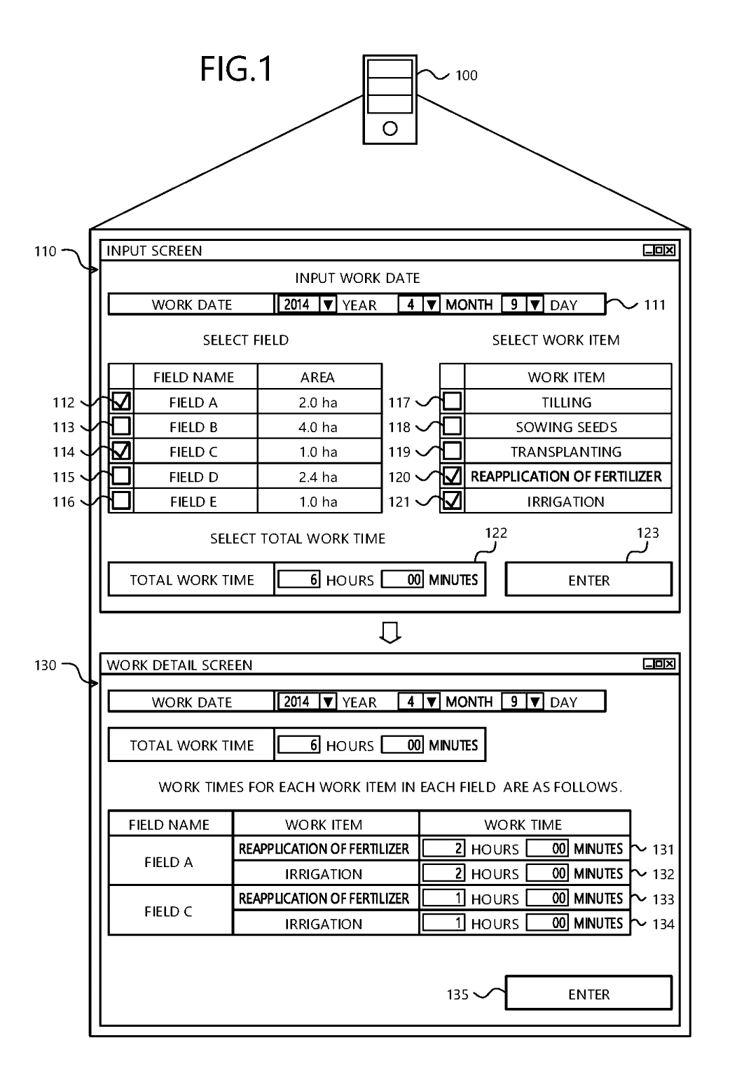

FIG. 1 is a diagram depicting one example of the farm-work-detail input support method according to an embodiment. In FIG. 1, an input support apparatus 100 is a computer configured to support input of a work details concerning farm work. Farm work is work for agricultural production and, for example, includes tilling, sowing seeds, transplanting, field rounds, fertilizer application, agrochemical application, reapplication of fertilizer, irrigation, etc. Further, work details concerning farm work is information that represents the amount of work performed by a worker engaged in farm work.

To understand the state of progress of farm work in fields, establish traceability according to field, etc., it is desirable to manage work details concerning farm work, for each work item performed in the fields. A field is farmland, cropland, etc. for cultivating and growing crops. A crop is a product produced by farming such as, for example, grains, vegetables, fruits, flowers, etc. A work item is a unit into which farm work is classified according to the contents of work.

In the field, it is often difficult for a worker to operate a terminal device such as a smartphone to input work details concerning farm work. For example, in the field, when farm work is performed, gloves such as knit work gloves are often worn to protect the hands of the worker, making it difficult to perform fine operations on a terminal device.

Therefore, for example, in many cases, the worker leaves the office when starting work, performs several farm work tasks in multiple fields, and when taking a break or finishing work, returns to the office and collectively inputs work details concerning work items for the fields in which farm work was performed. Collectively inputting work details concerning work items for the fields is a troublesome and burdensome task.

Thus, in the present embodiment, an input support method that simplifies the input of work details concerning work items for fields in which farm work was performed is described. An example of a farm work detail input support process of the input support apparatus 100 will be described. Here, a case where a personal computer (PC), a tablet PC, a smartphone, or the like is applied as the input support apparatus 100 will be described as an example.

(1) The input support apparatus 100 receives selection of a field, selection of a work item, and specification of a total work time. Here, a selected field is a field for which a farm work detail is to be input. Further, a selected work item is a work item for which a farm work detail is to be input. A specified total work time is the total work time for the farm work performed in the selected field.

In particular, for example, the input support apparatus 100 receives selection of a field, selection of a work item, and specification of a total work time by user operation of a non-depicted keyboard, mouse, touch panel, etc. For example, the input support apparatus 100 displays an input screen 110 for inputting a field, a work item, and the total work time.

Information identifying field selection candidates may be stored by the input support apparatus 100 or may be stored by another computer configured to communicate with the input support apparatus 100.

In the description below, a case where the user performs an operation of clicking items displayed on an operation screen as a selection operation will be described. In the input screen 110, by a user input operation, a box 111 is clicked, thereby enabling input of a work date on which farm work was performed. In the input screen 110, by a user input operation, check boxes 112 to 116 are clicked, thereby enabling selection of a field for which a farm work detail is to be input.

In the input screen 110, by a user input operation, check boxes 117 to 121 are clicked, thereby enabling selection of a work item for which a farm work detail is to be input. In the input screen 110, by a user input operation, a box 122 is clicked, thereby enabling specification the total work time for the farm work.

In the example depicted in FIG. 1, the work date “2014 Apr. 9” on which farm work was performed has been input to the box 111. The check boxes 112, 114 have been clicked, and field A and field C have been selected as fields for which a farm work detail is to be input. The check boxes 120, 121 have been clicked, and reapplication of fertilizer and irrigation have been selected as work items for which a farm work detail is to be input. The total work time “6 hours 00 minutes” of the farm work has been input in the box 122.

In the input screen 110, by a user input operation, a button 123 is clicked, thereby enabling selection of a field, selection of a work item, and specification of the total work time. In the example depicted in FIG. 1, a case is assumed where selection of field A and field C as fields for which a farm work detail is to be input is set, selection of reapplication of fertilizer and irrigation as work items for which a farm work detail is to be input is set, and specification of the total work time “6 hours 00 minutes” for the farm work is set.

(2) When multiple fields and multiple work items are selected, the input support apparatus 100, assigns all of the selected work items to all of the selected fields. In other words, in all of the selected fields, farm work for all of the selected work items is assumed to be performed. In the example depicted in FIG. 1, in the selected field A and field C, farm work for both of the selected work items “reapplication of fertilizer” and “irrigation” is assumed to be performed.

(3) The input support apparatus 100 distributes the specified total work time of the farm work corresponding to the selected fields and work items for output. In particular, for example, the input support apparatus 100 proportionately divides the specified total work time “6 hours 00 minutes” by the number of work items “2” selected. As a result, the total work time “6 hours 00 minutes” of the farm work may be distributed according to work item.

The input support apparatus 100 distributes corresponding to the respective areas of the fields, the work time “3 hours 00 minutes” obtained for the work items by proportionately dividing the total work time. Here, an area of a field, for example, is the planting area of a crop under cultivation in the field. When the planting area of a crop under cultivation in the field is large, the number of planted crops is often large and therefore, the work time for farm work in the field tends to be greater.

Thus, for example, the input support apparatus 100 controls the amount of work time distributed to each work item, obtained as a result of proportionately dividing corresponding to the respective areas of the selected fields. The input support apparatus 100 outputs the values obtained by the distribution, as the work times for each of the work items in each of the selected fields.

Information identifying the planting areas of the crop under cultivation in the field may be stored by the input support apparatus 100, or may be stored by another computer configured to communicate with the input support apparatus 100.

In the example depicted in FIG. 1, the ratio of the areas of field A and field C is “2:1”. Therefore, the work time “3 hours 00 minutes” for the work items “reapplication of fertilizer, irrigation” is distributed to field A and field C at the ratio of “2:1”. As a result, a work detail screen 130 displaying the work time for each of the work items in each of the fields is displayed.

In the work detail screen 130, in a box 131, the work time “2 hours 00 minutes” for the work item “reapplication of fertilizer” in field A is displayed as a work detail. In a box 132, the work time “2 hours 00 minutes” for the work item “irrigation” in field A is displayed as a work detail. In a box 133, the work time “1 hour 00 minutes” for the work item “reapplication of fertilizer” in field is displayed as a work detail. In a box 134, the work time “1 hour 00 minutes” for the work item “irrigation” in field C is displayed as a work detail.

In the work detail screen 130, clicking of the boxes 131 to 134 enables the work time for the work items in each of the fields to be changed. In the work detail screen 130, by a user input operation, clicking of a button 135 enables input of work times for work items in each of the fields to be set.

Thus, the input support apparatus 100 according to the present embodiment enables the total work time of farm work to be distributed to each work item in each field and output, when farm work for multiple work items is performed in multiple fields. As a result, a rough work time may be identified for each work item in fields where farm work was performed, enabling input of work details for multiple work items in multiple fields to be simplified.

In the example depicted in FIG. 1, when work details for the work items “reapplication of fertilizer, irrigation” in the fields “field A, field C” are collectively input, rough work times for each work item in each field are displayed. Thus, the burden of inputting farm work details may be reduced compared to manually inputting work details for each of the work items in each field from scratch.

A case where the input support apparatus 100 depicted in FIG. 1 is applied to a farming support system 200 will be described.

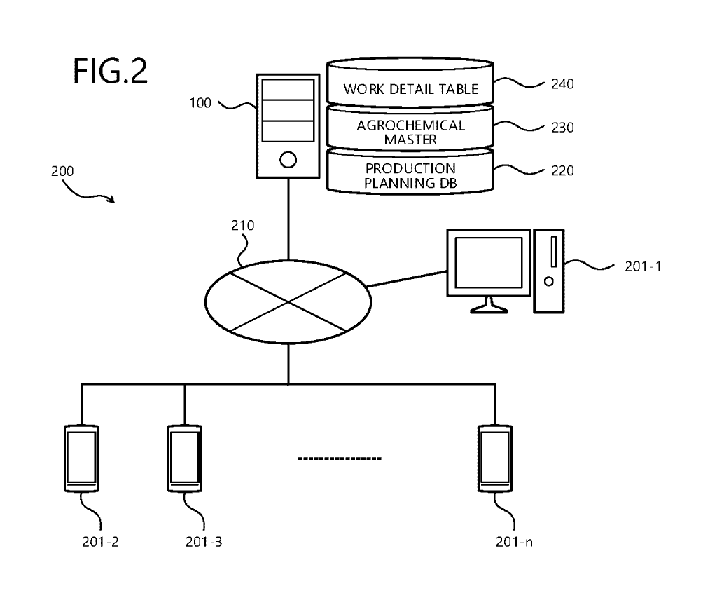

FIG. 2 is a diagram depicting an example of system configuration of the farming support system 200. In FIG. 2, the farming support system 200 is configured to include the input support apparatus 100 and client apparatuses 201-1 to 201-n (where, n is a natural number of 2 or more). In the farming support system 200, the input support apparatus 100 and the client apparatuses 201-1 to 201-n are connected through a wired or wireless network 210. The network 210, for example, is a local area network (LAN), a wide area network (WAN), the Internet, etc.

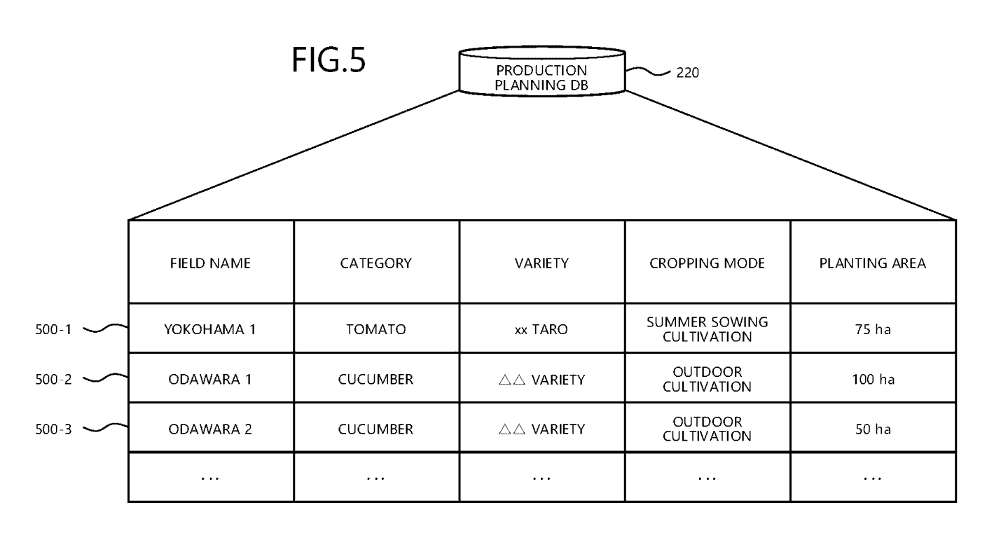

Here, the input support apparatus 100 has a production plan database (DB) 220, an agrochemical master 230, and a work detail table 240, and performs display control of the client apparatuses 201-1 to 201-n. The input support apparatus 100, for example, is a server. Contents of the various DBs 220, 230, 240 will be described with reference to FIGS. 5 to 8.

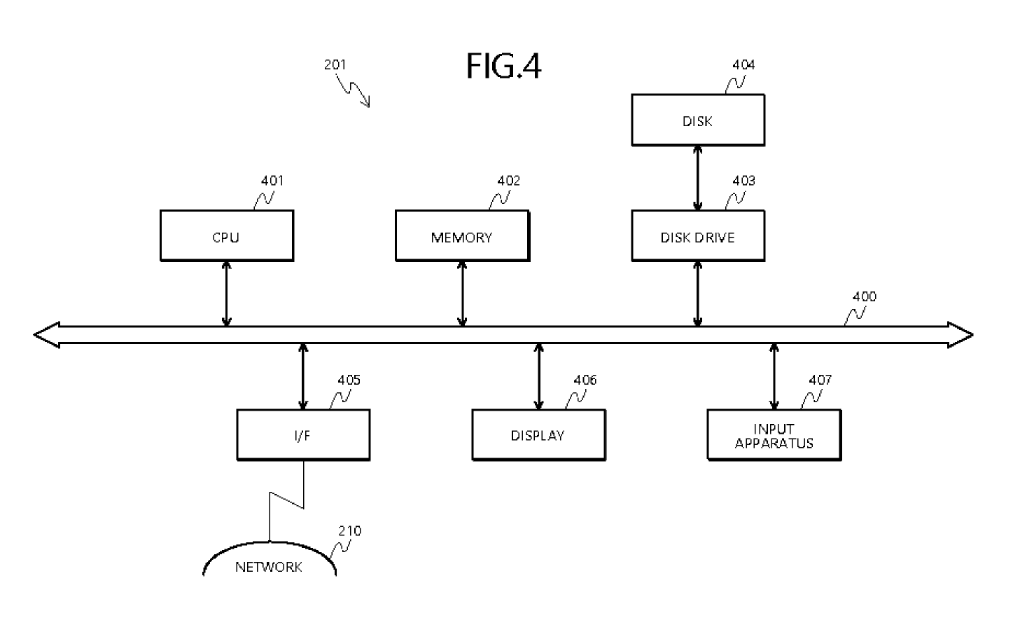

The client apparatuses 201-1 to 201-n have a display (e.g., a display 406 depicted in FIG. 4 and described hereinafter), and are computers configured to display various screens under the control of the input support apparatus 100. The client apparatuses 201-1 to 201-n, for example, are PCs, note PCs, tablet PCs, smartphones, etc. used by farm managers and workers.

In particular, for example, when receiving display requests for various types of screens from the client apparatuses 201-1 to 201-n, the input support apparatus 100 generates screen information for the various screens and transmits the screen information to the client apparatuses 201-1 to 201-n. As a result, the various screens are displayed on the displays of the client apparatuses 201-1 to 201-n.

In the description hereinafter, the client apparatuses 201-1 to 201-n may be simply indicated as “client apparatus 201”.

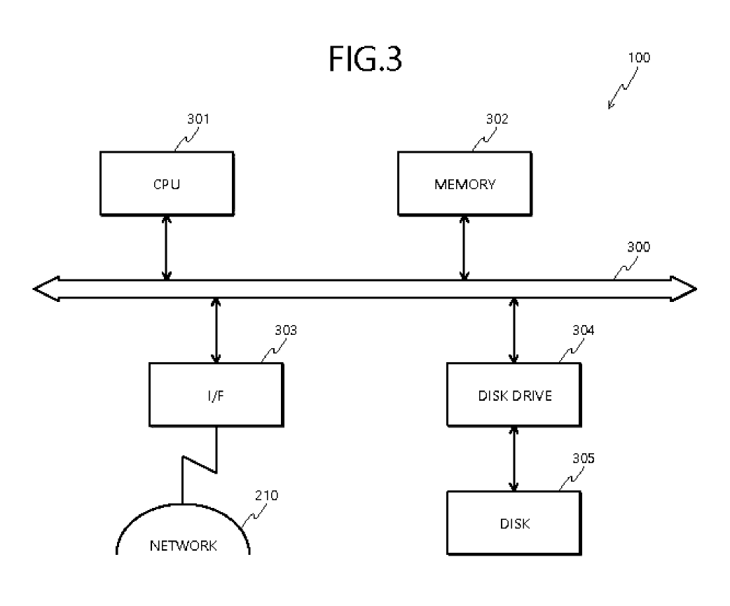

FIG. 3 is a block diagram depicting an example of hardware configuration of the input support apparatus 100. In FIG. 3, the input support apparatus 100 has a central processing unit (CPU) 301, a memory 302, an interface (I/F) 303, a disk drive 304, and a disk 305, respectively connected by a bus 300.

Here, the CPU 301 governs overall control of the input support apparatus 100. The memory 302, for example, includes a read-only memory (ROM), a random access memory (RAM), and a flash ROM. In particular, for example, the flash ROM and ROM store various programs and the RAM is used as work area of the CPU 301. Programs stored in the memory 302 are loaded onto the CPU 301, whereby encoded processes are executed by the CPU 301.

The I/F 303 is connected to the network 210 through a communications line and is connected to other computers (e.g., the client apparatus 201 depicted in FIG. 2) through the network 210. The I/F 303 administers an internal interface with the network 210 and controls the input and output of data from other computers. The I/F 303, for example, may be a modem, a LAN adapter, or the like.

The disk drive 304, under the control of the CPU 301, controls the reading and writing of data with respect to the disk 305. The disk 305 stores data written thereto under the control of the disk drive 304. The disk 305, for example, may be an electromagnetic disk, an optical disk, or the like.

In addition to the configuration above, the input support apparatus 100 may have, for example, a solid state drive (SSD), a keyboard, a mouse, a display, and the like.

FIG. 4 is a block diagram depicting an example of hardware configuration of a client apparatus 201. In FIG. 4, the client apparatus 201 has a CPU 401, a memory 402, a disk drive 403, a disk 404, an I/F 405, the display 406, and an input apparatus 407, respectively connected by a bus 400.

Here, the CPU 401 governs overall control of the client apparatus 201. The memory 402, for example, has a ROM, a RAM, and a flash ROM. In particular, for example, the flash ROM and ROM store various programs, and the RAM is used as a work area of the CPU 401. The programs stored in the memory 402 are loaded onto the CPU 401 whereby, encoded processes are executed by the CPU 401.

The disk drive 403, under the control of the CPU 401, controls the reading and writing of data with respect to the disk 404. The disk 404 stores data written thereto under the control of the disk drive 403. The disk 404, for example, may be a magnetic disk, an optical disk, etc.

The I/F 405 is connected to the network 210 through a communications line and is connected to other computers (e.g., the input support apparatus 100 depicted in FIG. 2) through the network 210. The I/F 405 administers an internal interface with the network 210, and controls the input and output of data from other computers.

The display 406 displays data such as documents, images, and functional information in addition to a cursor, icons, and toolboxes. The display 406, for example, may be a cathode ray tube (CRT), a liquid crystal display, an organic Electroluminescence (EL) display, etc.

The input apparatus 407 has keys for inputting characters, numerals, instructions, etc. and performs input of data. The input apparatus 407 may be a keyboard, a mouse, a touch panel input pad, a numeric pad, etc.

Among the components above, for example, the client apparatus 201 may omit the disk drive 403, the disk 404, etc. Further, in addition to the components above, the client apparatus 201, for example, may have a SSD, a scanner, a printer, etc.

The contents of the various DBs 220, 230, 240 will be described with reference to FIGS. 5 to 7. The various DBs 220, 230, and 240, for example, are realized by the memory 302 and the disk 305 of the input support apparatus 100, depicted in FIG. 3.

FIG. 5 is a diagram depicting an example of the contents of the production plan DB 220. In FIG. 5, the production plan DB 220 has input fields for field names, categories, varieties, cropping modes, and planting areas. Information is set into the input fields, whereby production plan information (e.g., production plan information 500-1 to 500-3) is stored as records.

Here, a production plan is a plan indicating the field and how much of a crop to be produced is to be planted in the field. The cultivation of crops in the fields is performed according to the production plan. A field name is the name of a field. For example, a single field may be divided into sectors and a sector name may be used as a field name. A category is a type of crop. For example, a category may be tomato, cucumber, paddy rice, cabbage, etc.

A variety is a type within the same category. For example, varieties of cabbage include summer sown varieties: “ayakaze”, “green bowl”; spring sown varieties: “early cabbage No. 2”, “early cabbage No. 3”, “akiwasei”, “shinkaze”, etc. A cropping mode is a system of a combination of techniques and conditions for cultivating a crop. A cropping mode, for example, may be house cultivation, outdoor cultivation, summer sowing cultivation, etc. A planting area is the area (measure of land) in which a crop is planted.

In addition to the information above, for example, plans such as cultivation guidelines, a planned start date for cultivation, a planned end date for cultivation, a cultivation period, a harvest amount, etc. may be stored in the production plan DB 220. Cultivation guidelines are objectives and policies related to farming. A farm manager, for example, from the perspective of environmental protection, may set as a cultivation guideline, an objective of limiting the agrochemicals used.

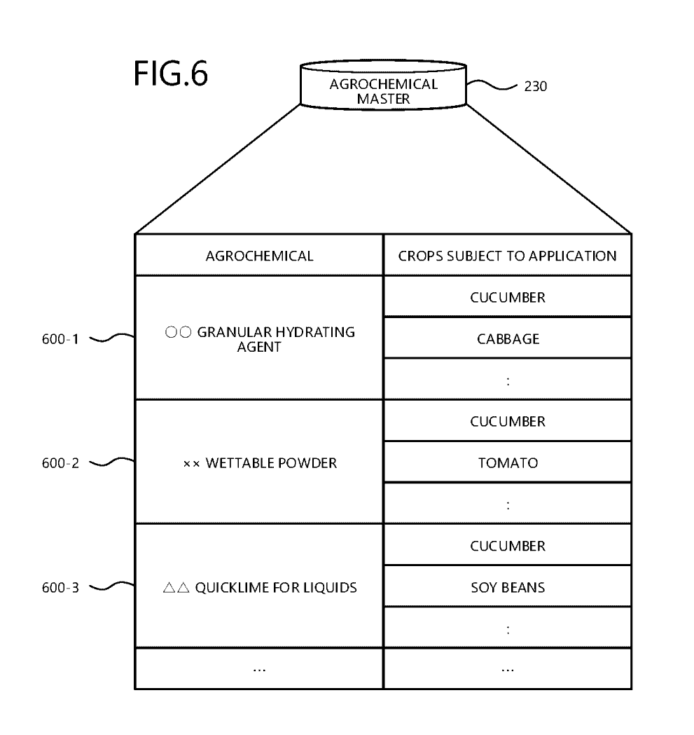

FIG. 6 is a diagram depicting an example of the contents of the agrochemical master 230. In FIG. 6, the agrochemical master 230 has input fields for agrochemicals and crops subject to application, and stores agrochemical information (e.g., agrochemical information 600-1 to 600-3) consequent to information being set into the input fields.

Here, an agrochemical is a chemical used in agriculture. In addition to fungicides and insecticides used to kill harmful bacteria, nematodes, mites, insects, animals and plants, viruses, an agrochemical may be a germination inhibitor or plant growth regulator used to suppress or enhance physiological function of a crop. In the agrochemical field, for example, the name or type of agrochemical is set.

A crop subject to application, is a crop specified to be subject to agrochemical application. In the crop input field, for example, the category of a crop is set. For example, the agrochemical information 600-1 indicates the categories “cucumber, cabbage, . . . ” of crops specified to be subject to application of an agrochemical “oo granular hydrating agent”.

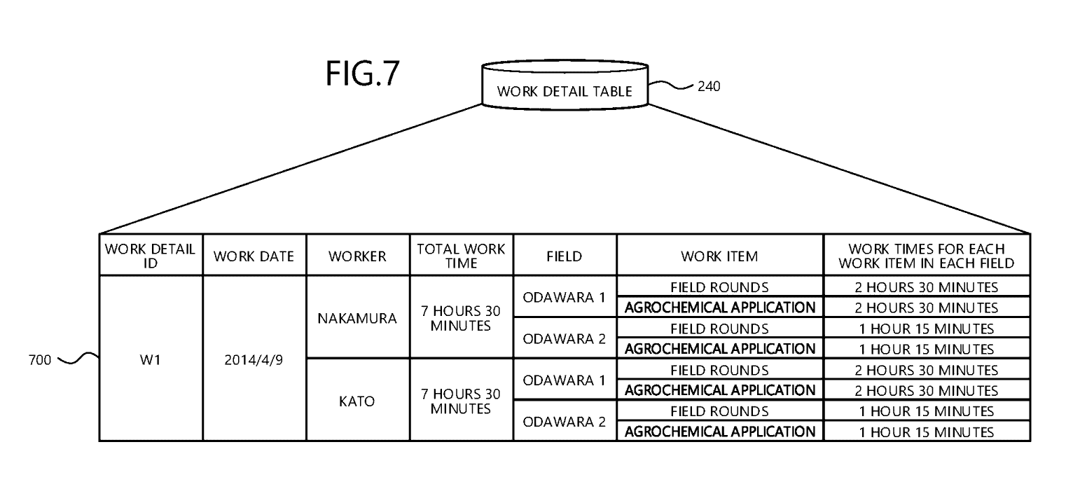

FIG. 7 is a diagram depicting an example of the contents of the work detail table 240. In FIG. 7, the work detail table 240 has input fields for work detail IDs, work dates, workers, total work times, fields, work items, and work times for each field work item. Information is set into the input fields whereby work detail information (e.g., work detail information 700) indicating work details concerning farm work is stored.

Here, a work detail ID is an identifier of work detail information. A work date is the date on which farm work was performed. A worker is the worker who performed the farm work. The total work time is the total work time that farm work was performed. A field is the field in which the farm work was performed. A work item is a work item of farm work performed in the field. The work time for a field*work item is the work time for each work item performed in the fields.

For example, the work detail information 700 indicates that worker “Nakamura” performed farm work for a total work time of “7 hours 30 minutes” in the fields “Odawara 1, Odawara 2” on the work date “2014/4/9”. Further, among the total work time “7 hours 30 minutes” for the farm work performed in the field “Odawara 1”, a work time of “2 hours 30 minutes” was consumed for the farm work “field rounds” and a work time of “2 hours 30 minutes” was consumed for the farm work “agrochemical application”. Further, among the total work time “7 hours 30 minutes” for the farm work performed in the field “Odawara 2”, a work time of “1 hour 15 minutes” was consumed for the farm work “field rounds” and a work time of “1 hour 15 minutes” was consumed for the farm work “agrochemical application”.

When “agrochemical application” is included among work items of the farm work, work detail information includes agrochemical application detail information indicating work details for agrochemical application. Here, a detailed example of the agrochemical application detail information will be described.

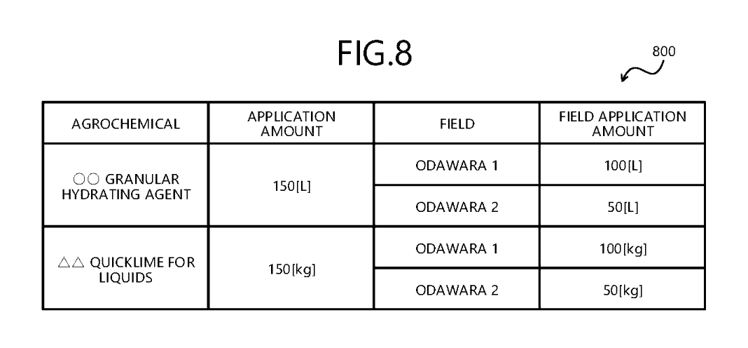

FIG. 8 is a diagram depicting a detailed example of agrochemical application detail information. In FIG. 8, agrochemical application detail information 800 is information included in the work detail information 700 and indicates a work detail for agrochemical application. The agrochemical application detail information 800 indicates an application amount “150 [L]” of the agrochemical “oo granular hydrating agent” applied to the fields “Odawara 1, Odawara 2”. The agrochemical application detail information 800 further indicates that of the application amount “150 [L]” of the agrochemical “oo granular hydrating agent”, a field application amount “100 [L]” was applied to the field “Odawara 1” and a field application amount “50 [L]” was applied to the field “Odawara 2”.

The agrochemical application detail information 800 indicates an application amount “150 [kg]” of the agrochemical “AA quicklime for liquids” applied to the fields “Odawara 1, Odawara 2”. The agrochemical application detail information 800 indicates that of the application amount “150 [kg]” of the agrochemical “AA quicklime for liquids”, a field application amount “100 [kg]” was applied to the field “Odawara 1” and a field application amount “50 [kg]” was applied to the field “Odawara 2”.

An example of a work recording screen displayed on the display 406 of the client apparatus 201 will be described.

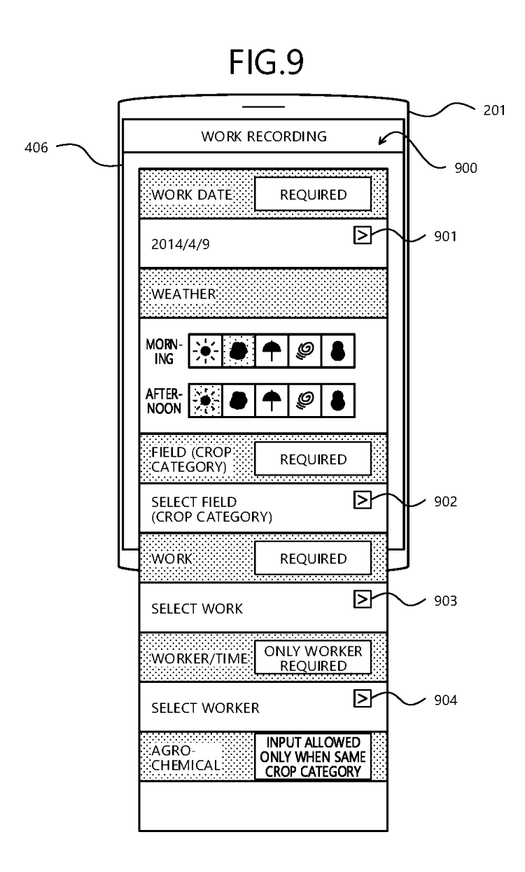

FIG. 9 is a diagram depicting an example of a work recording screen (part 1). In FIG. 9, a work recording screen 900 is an operation screen that becomes a main screen when input of work details concerning farm work is performed. In FIG. 9, among the display contents of the work recording screen 900, a portion not fitting on the screen is virtually displayed.

In the work recording screen 900, by a user input operation using the input apparatus 407 depicted in FIG. 4, an icon 901 is clicked, thereby enabling input of a work date when farm work was performed. In the example depicted in FIG. 9, the work date “2014 Apr. 9” on which farm work was performed has been input. When a work date is input, the weather in the morning and afternoon of the work date is displayed.

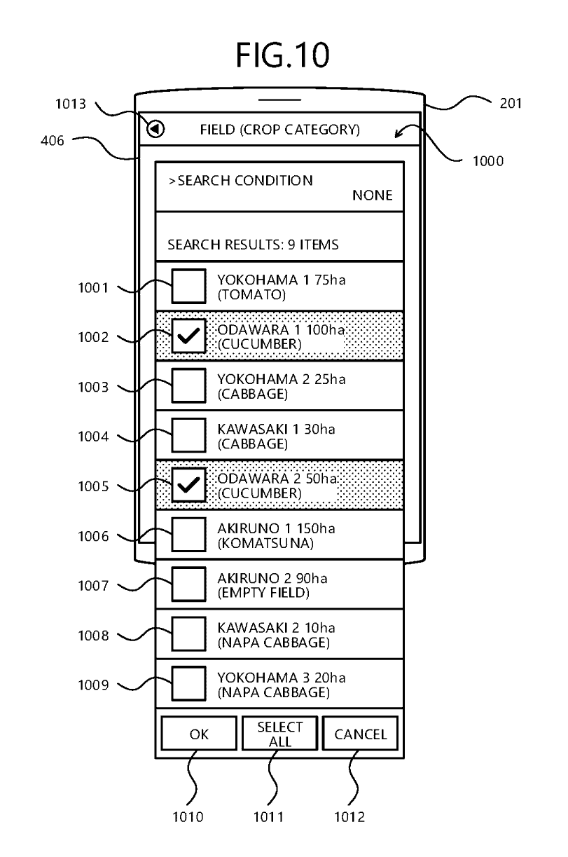

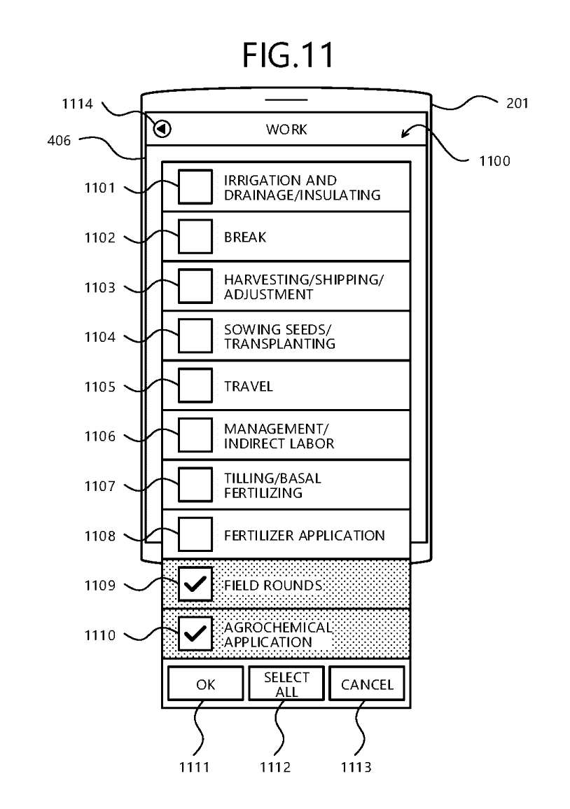

In the work recording screen 900, an icon 902 is clicked to transition to a field selection screen 1000 depicted in FIG. 10 and described hereinafter, and enable selection of a field for which work details concerning farm work are to be input. In the work recording screen 900, an icon 903 is clicked to transition to a work item selection screen 1100 depicted in FIG. 11 and described hereinafter, and enable selection of a work item for which work details concerning farm work are to be input. A work item is a unit into which farm work is classified according to the contents of the work.

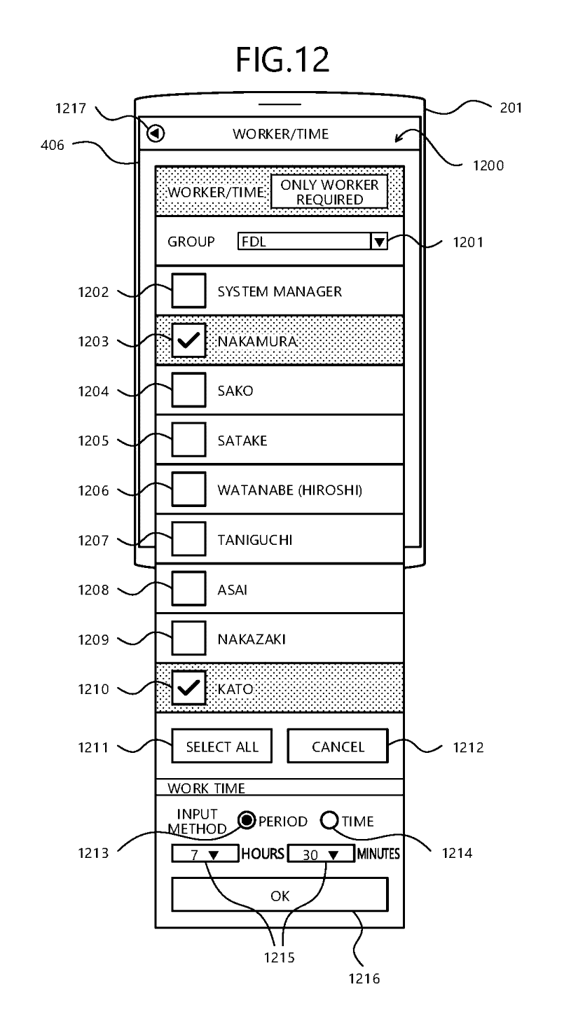

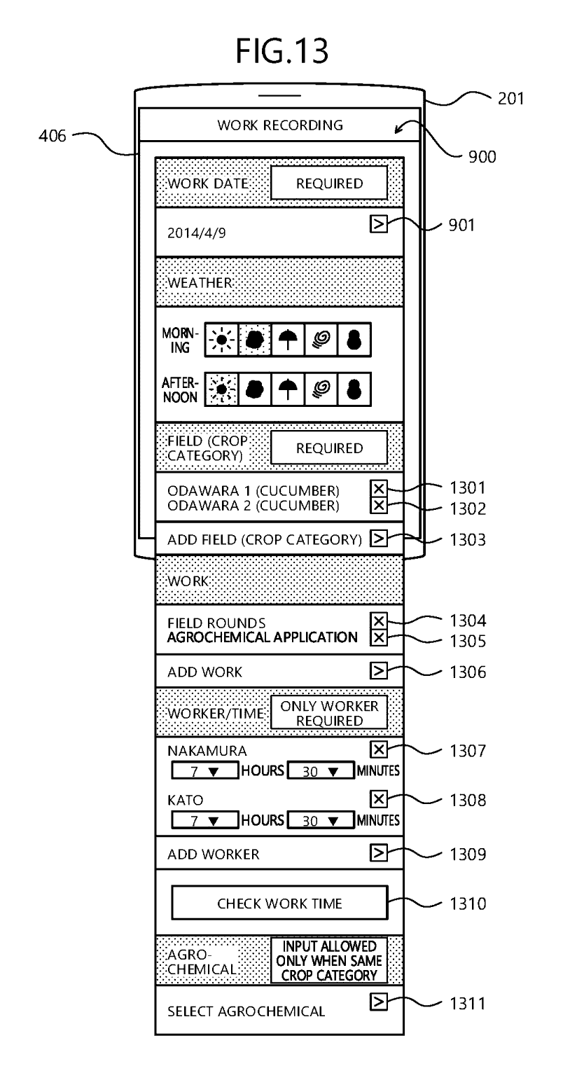

In the work recording screen 900, an icon 904 is clicked to transition to a worker selection screen 1200 depicted in FIG. 12 and described hereinafter, and enable selection of a worker for whom work details concerning farm work are to be input. In the work recording screen 900, although an icon (e.g., an icon 1311 depicted in FIG. 13 and described hereinafter) for transitioning to an operation screen that receives input of an agrochemical application detail may be displayed, at the time point of FIG. 9, control is performed so as to not allow input of an agrochemical application detail.

An example of a field selection screen displayed on the display 406 of the client apparatus 201 will be described. A field selection screen, for example, is an operation screen transitioned to by clicking the icon 902 in the work recording screen 900 depicted in FIG. 9.

FIG. 10 is a diagram depicting an example of a field selection screen. In FIG. 10, the field selection screen 1000 is an operation screen for selecting a field for which work details concerning farm work are to be input. In FIG. 10, among the display contents of the field selection screen 1000, a portion not fitting on the screen is virtually displayed.

In the field selection screen 1000, a field group matching search conditions (e.g., keyword specification, area specification, etc.) specified by a user input operation are displayed as selection candidates. In the field selection screen 1000, field names of the field selection candidates are displayed with the category and planting area of a crop planted in the field.

In the field selection screen 1000, check boxes 1001 to 1009 are clicked, thereby enabling selection of a field for which work details concerning farm work are to be input. In the example depicted in FIG. 10, the check boxes 1002, 1005 have been clicked and “Odawara 1” and “Odawara 2” have been selected as fields for which a farm work detail is to be input.

In the field selection screen 1000, a button 1010 is clicked to set the field selection. In the field selection screen 1000, a button 1011 is clicked, thereby enabling selection of all the field selection candidates. In the field selection screen 1000, a button 1012 is clicked, thereby enabling release of field selection. In the field selection screen 1000, a button 1013 is clicked, thereby enabling return to the work recording screen 900 depicted in FIG. 9.

An example of a work item selection screen displayed on the display 406 of the client apparatus 201 will be described. The work item selection screen, for example, is an operation screen transitioned to by clicking the icon 903 in the work recording screen 900 depicted in FIG. 9.

FIG. 11 is a diagram depicting an example of a work item selection screen. In FIG. 11, a work item selection screen 1100 is an operation screen for selecting a work item for which work details concerning farm work are to be input. In FIG. 11, among the display contents of the work item selection screen 1100, a portion not fitting on the screen is virtually displayed.

In the work item selection screen 1100, check boxes 1101 to 1110 are clicked, thereby enabling selection of a work item for which work details concerning farm work are to be input. In the example depicted in FIG. 11, check boxes 1109, 1110 have been clicked and “field rounds” and “agrochemical application” have been selected as work items for which a farm work detail is to be input.

In the work item selection screen 1100, a button 1111 is clicked, thereby enabling setting of the work item selection. In the work item selection screen 1100, a button 1112 is clicked, thereby enabling selection of all the work item selection candidates. In the work item selection screen 1100, a button 1113 is clicked, thereby enabling release of work item selection. In the work item selection screen 1100, a button 1114 is clicked, thereby enabling return to the work recording screen 900 depicted in FIG. 9.

An example of the worker selection screen displayed on the display 406 of the client apparatus 201 will be described. The worker selection screen, for example, is an operation screen transitioned to by clicking the icon 904 in the work recording screen 900 depicted in FIG. 9.

FIG. 12 is a diagram depicting an example of a worker selection screen. In FIG. 12, a worker selection screen 1200 is an operation screen for selecting a worker for whom work details concerning farm work are to be input. In FIG. 12, among the display contents of the worker selection screen 1200, a portion not fitting on the screen is virtually displayed.

In the worker selection screen 1200, a box 1201 is clicked, thereby enabling designation of a group to which a worker selection candidate belongs. In the example depicted in FIG. 12, a group “FDL” has been designated and the workers belonging to the group “FDL” are displayed as worker selection candidates.

In the worker selection screen 1200, check boxes 1202 to 1210 are clicked, thereby enabling selection of a worker for whom work details concerning farm work are to be input. In the example depicted in FIG. 12, the check boxes 1203, 1210 have been clicked and “Nakamura” and “Kato” have been selected as workers for whom a farm work detail is to be input.

In the worker selection screen 1200, a button 1211 is clicked, thereby enabling selection of all the worker selection candidates. In the worker selection screen 1200, a button 1212 is clicked, thereby enabling release of worker selection.

In the worker selection screen 1200, check boxes 1213, 1214 are clicked, thereby enabling selection of an input method of the total work time for the farm work. For example, the check box 1213 is clicked whereby a box 1215 is displayed to enable input of the “period” of the total work time for the farm work.

On the other hand, a check box 1214 is clicked to display a box (not depicted) to input a start and end time of the farm work, enabling the “time” of the total work time for the farm work to be input. In the example depicted in FIG. 12, the check box 1213 has been clicked and the total work time “7 hours 30 minutes” of the farm work has been input to the box 1215.

In the worker selection screen 1200, a button 1216 is clicked, thereby enabling setting of the worker selection. In the worker selection screen 1200, a button 1217 is clicked, thereby enabling return to the work recording screen 900 depicted in FIG. 9.

An example of a work recording screen displayed on the display 406 of the client apparatus 201, resulting from various operations via the various screens 1000, 1100, 1200 depicted in FIGS. 10 to 12 will be described.

FIG. 13 is a diagram depicting an example of the work recording screen (part 2). In FIG. 13, in the work recording screen 900, “Odawara 1” and “Odawara 2” selected as fields for which work details concerning farm work are to be input are displayed.

In the work recording screen 900, icons 1301, 1302 are clicked, thereby enabling release of the field selection. In the work recording screen 900, an icon 1303 is clicked to transition to the field selection screen 1000 (refer to FIG. 10) to enable addition of a field for which work details concerning farm work are to be input.

In the work recording screen 900, “field rounds” and “agrochemical application” selected as work items for which work details concerning farm work are to be input are displayed.

In the work recording screen 900, icons 1304, 1305 are clicked, thereby enabling release of work item selection. In the work recording screen 900, an icon 1306 is clicked to transition to the work item selection screen 1100 (refer to FIG. 11) to enable addition of a work item for which work details concerning farm work are to be input.

In the work recording screen 900, “Nakamura” and “Kato” selected as workers for whom work details concerning farm work are to be input are displayed. In the work recording screen 900, the work time “7 hours 30 minutes” input as the total work time for the farm work is assigned to each worker and displayed.

In the work recording screen 900, icons 1307, 1308 are clicked, thereby enabling release of worker selection. In the work recording screen 900, an icon 1309 is clicked to transition to the worker selection screen 1200 (refer to FIG. 12), and enable addition of a worker for whom work details concerning farm work are to be input.

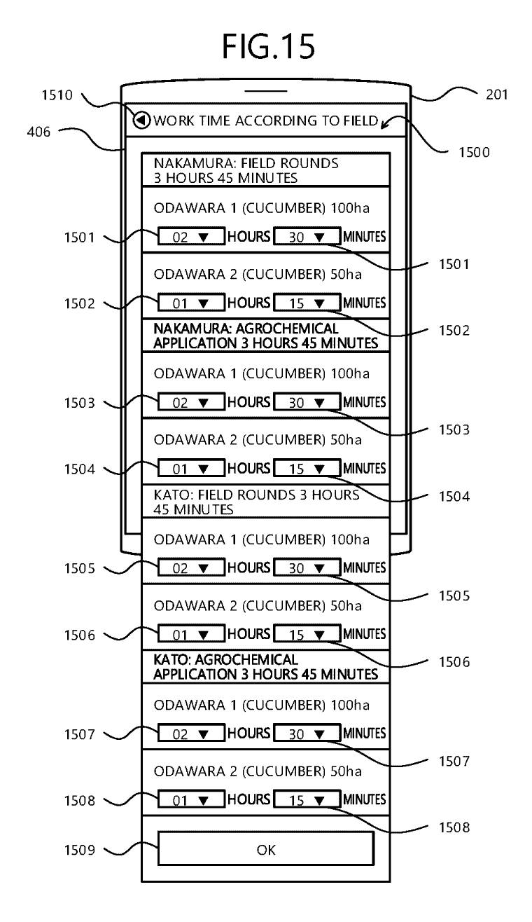

In the work recording screen 900, a button 1310 is clicked, thereby enabling transition to a work time screen displaying work times for each work item in each field. An example of a work time screen will be described with reference to FIG. 15.

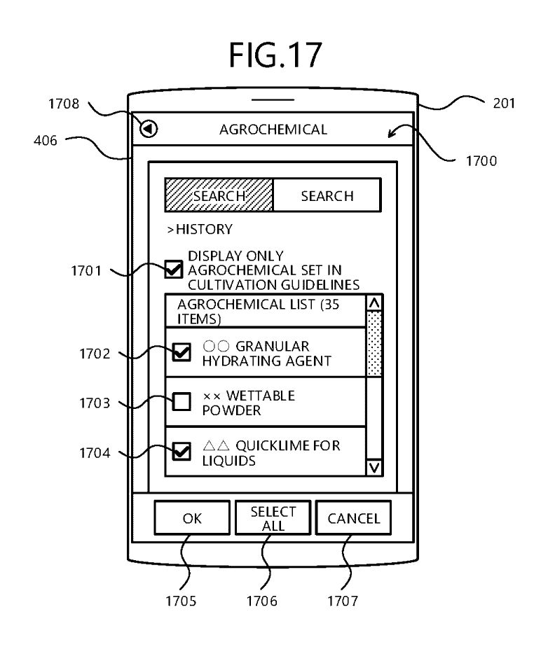

In the work recording screen 900, the icon 1311 for transitioning to an operation screen that receives input of an agrochemical application detail is displayed. In the work recording screen 900, the icon 1311 is clicked, thereby enabling transition to an agrochemical selection screen that receives selection of an agrochemical applied to a field. An example of the agrochemical selection screen will be described with reference to FIG. 17.

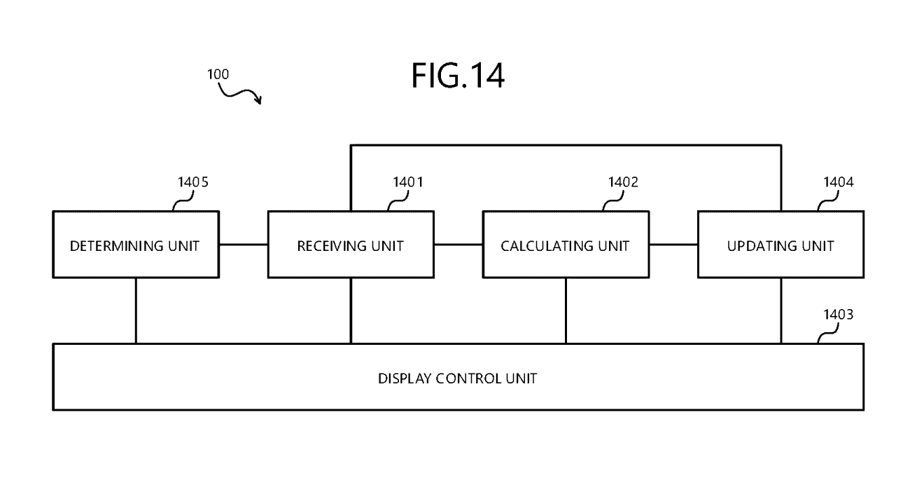

FIG. 14 is a block diagram of an example of a functional configuration of the input support apparatus 100. In FIG. 14, the input support apparatus 100 is configured to include a receiving unit 140, a calculating unit 1402, a display control unit 1403, an updating unit 1404, and a determining unit 1405. The receiving unit 1401 to the determining unit 1405 are functions forming a control unit and in particular, for example, are realized by executing on the CPU 301, a program stored in a storage apparatus such as the memory 302, the disk 305 depicted in FIG. 3, or by the I/F 303. Processing results of the functional units, for example, are stored to a storage apparatus such as the memory 302, the disk 305, etc.

The receiving unit 1401 receives designation of a work date for which a farm work detail is to be input. Designation of a work date for which a farm work detail is to be input, for example, is performed in the work recording screen 900 (refer to FIG. 9), by a user input operation of the client apparatus 201. The user, for example, is a worker who performed the farm work, or a farm manager who manages such workers.

The client apparatus 201 transmits the designated work date to the input support apparatus 100. In this case, the receiving unit 1401 receives the designation result from the client apparatus 201 and thereby, receives designation of the work date for which a farm work detail is to be input. The designated work date for which a farm work detail is to be input, for example, is stored to the work detail table 240 (refer to FIG. 7).

The receiving unit 1401 receives selection of a field for which a farm work detail is to be input. Selection of a field for which a farm work detail is to be input, for example, is performed in the field selection screen 1000 (refer to FIG. 10), by a user input operation of the client apparatus 201.

The client apparatus 201 transmits the selected field to the input support apparatus 100. In this case, the receiving unit 1401 receives the selection result for the field from the client apparatus 201 and thereby, receives selection of a field for which a farm work detail is to be input. The selected field, for example, is stored to the work detail table 240.

The receiving unit 1401 receives selection of a work item for which a farm work detail is to be input. The selection of the work item for which a farm work detail is to be input, for example, is performed in the work item selection screen 1100 (refer to FIG. 11), by a user input operation of the client apparatus 201.

The client apparatus 201 transmits the selected work item to the input support apparatus 100. In this case, the receiving unit 1401 receives the selection result for the work item from the client apparatus 201 and thereby, receives selection of a work item for which a farm work detail is to be input. The selected work item, for example, is stored to the work detail table 240.

The receiving unit 1401 receives selection of a worker for whom a farm work detail is to be input. Selection of a worker for whom a farm work detail is to be input, for example, is performed in the worker selection screen 1200 (refer to FIG. 12), by a user input operation of the client apparatus 201.

The client apparatus 201 transmits the selected worker to the input support apparatus 100. In this case, the receiving unit 1401 receives the selection result for the worker from the client apparatus 201 and thereby, receives selection of a worker for whom a farm work detail is to be input. The selected worker, for example, is stored to the work detail table 240.

The receiving unit 1401 receives designation of the total work time for the farm work performed in a field for which a farm work detail is to be input. Here, the total work time for the farm work is the total work time per worker. Designation of the total work time for the farm work, for example, is performed in the worker selection screen 1200 (refer to FIG. 12), by a user input operation of the client apparatus 201.

The client apparatus 201 transmits the designated total work time to the input support apparatus 100. In this case, the receiving unit 1401 receives the designation result for the total work time from the client apparatus 201 and thereby, receives designation of the total work time for the farm work. The designated total work time, for example, is stored to the work detail table 240.

When multiple fields and multiple work items have been selected, the calculating unit 1402 assigns all of the selected work items to all of the selected fields. The calculating unit 1402 distributes the designated total work time for the farm work to each of the work items in each of the fields.

In particular, for example, the calculating unit 1402 proportionately divides the total work time for the farm work by the selected number of work items. The calculating unit 1402 distributes the obtained work time for each work item, corresponding to the respective areas of the fields. The calculating unit 1402 records the distributed values as the work times for each of the work items in each of the fields.

Here, the area of a field, for example, is the planting area of a crop under cultivation in the field. The planting area of a crop planted in the fields, for example, is identified from production plan information of the fields in the production plan DB 220. When the planting area of the crop under cultivation in the field is large, the work time for farm work in the field tends to increase. Therefore, the calculating unit 1402, for example, controls the amount of work time distributed to each work item obtained as a result of proportionately dividing corresponding to the respective areas of the selected fields.

For example, as depicted in FIG. 10, “Odawara 1” and “Odawara 2” are assumed to be selected as fields and as depicted in FIG. 11, “field rounds” and “agrochemical application” are assumed to be selected as work items. Further, as depicted in FIG. 12, “7 hours 30 minutes” is assumed to be designated as the total work time of the workers.

In this case, the calculating unit 1402 proportionately divides the total work time for the farm work “7 hours 30 minutes” by the number of selected work items “2”. As a result, the total work time for the farm work “7 hours 30 minutes” may be distributed to each work item. Corresponding to the respective areas of the selected fields “Odawara 1” and “Odawara 2”, the calculating unit 1402 distributes the work time “3 hours 45 minutes” obtained for each of the work items “field rounds” and “agrochemical application”.

Here, the ratio of planting areas of the field “Odawara 1” and field “Odawara 2” is “2 (100 ha):1 (50 ha)”. Therefore, the calculating unit 1402 distributes the work time “3 hours 45 minutes” for the work items “field rounds” and “agrochemical application” to the field “Odawara 1” and fields “Odawara 2” at the ratio of “2:1”.

As a result, the work time for each of the work items “field rounds” and “agrochemical application” in the field “Odawara 1” is “2 hours 30 minutes”. Further, the work time for the work items “field rounds” and “agrochemical application” in the field “Odawara 2” is “1 hour 15 minutes”. The work time for each of the work items in each of the fields, for example, is stored to the work detail table 240.

The display control unit 1403 controls the display of the stored work times for the work items in each of the fields. In particular, for example, the display control unit 1403 generates screen information for a work time screen (e.g., a work time screen 1500 depicted in FIG. 15 and described hereinafter) displaying the work time for each of the work items in each of the fields and transmits the generated screen information to the client apparatus 201.

The receiving unit 1401 receives input of changes to the work times for each of the work items in each of the fields. A change to a work time of a work item in a field, for example, is performed in the work time screen 1500 described hereinafter (refer to FIG. 15), by a user input operation of the client apparatus 201.

The client apparatus 201 transmits the change result of a work time for a work item in a field to the input support apparatus 100. In this case, the receiving unit 1401 receives the change result from the client apparatus 201 and thereby, receives a change of a work time for a work item in a field.

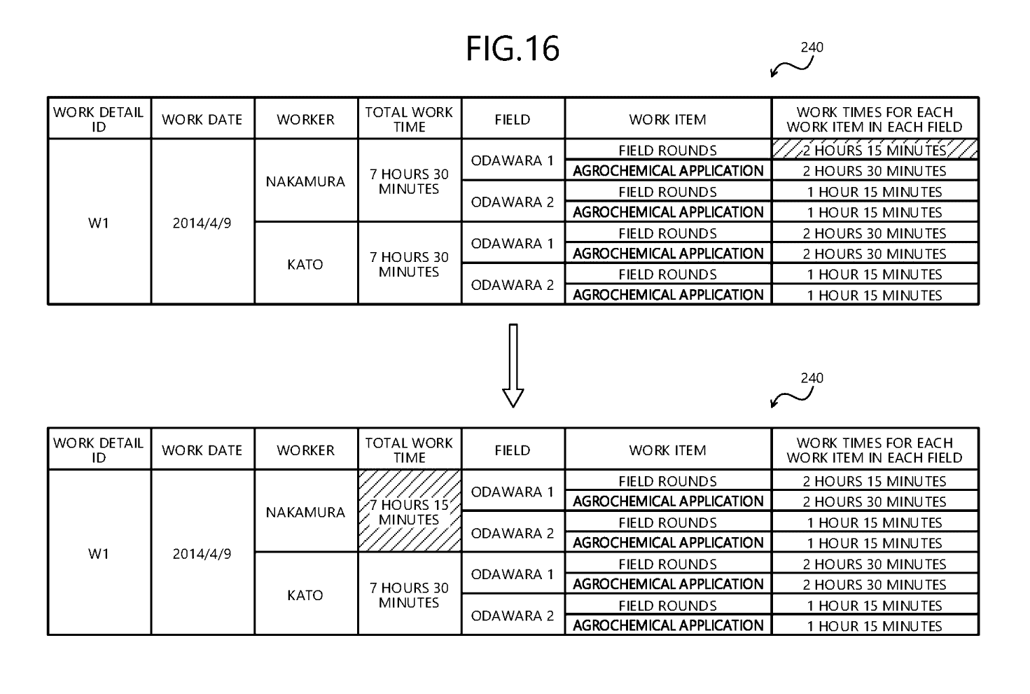

The updating unit 1404 updates the total work time for the farm work, based on the received post-change work time. In particular, for example, the updating unit 1404 updates the corresponding work time for the field-work item in the work detail table 240 by the received post-change work time. The updating unit 1404 calculates a total value of the work times for the field•work items for each worker. The updating unit 1404 updates the corresponding total work time in the work detail table 240 by the calculated total value of the work times for the field•work items for each worker. An example of the total work time for the farm work will be described hereinafter with reference to FIG. 16.

When multiple fields are selected, the determining unit 1405 determines whether planted crops associated with each of the selected fields is the same crop. In particular, for example, the determining unit 1405 refers to the production plan DB 220 (refer to FIG. 5) and determines whether the category of the planted crops associated with each of the selected fields is the same.

The display control unit 1403 controls whether input of an agrochemical application detail for the selected fields is to be permitted, corresponding the determination result. In particular, for example, when the planted crops are the same, the display control unit 1403 permits input of an agrochemical application detail for the fields.

For example, when the planted crops are the same, the display control unit 1403 controls the client apparatus 201 to display on the work recording screen 900, the icon 1311 (refer to FIG. 13) for transitioning to an operation screen that receives input of an agrochemical application detail for the fields.

On the other hand, when the planted crops are not the same, the display control unit 1403 restricts input of an agrochemical application detail for the fields. For example, when the planted crops are not the same, the display control unit 1403 controls the client apparatus 201 to restrict transition to an input screen for agrochemical application details.

The display control unit 1403 controls the display of an agrochemical selection screen for selecting an agrochemical applied to a field. In particular, for example, when the icon 1311 (refer to FIG. 13) is clicked in the work recording screen 900, the display control unit 1403 refers to the agrochemical master 230 (refer to FIG. 6) and identifies agrochemicals applied to a crop that is the planted crop in the selected fields.

The display control unit 1403 generates screen information for an agrochemical selection screen including the identified agrochemicals as selection candidates and transmits the generated screen information to the client apparatus 201. As a result, an agrochemical selection screen (e.g., an agrochemical selection screen 1700 depicted in FIG. 17 and described hereinafter) is displayed on the display 406 of the client apparatus 201.

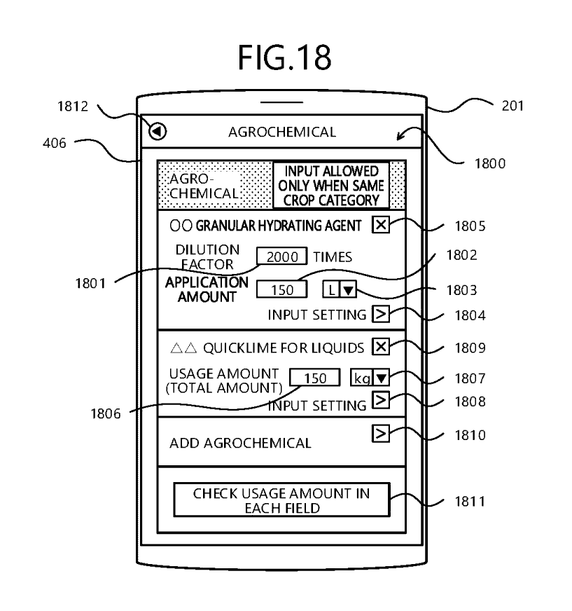

The display control unit 1403 controls the display of an application detail input screen for inputting an application amount of an agrochemical. In particular, for example, when a button 1705 on the agrochemical selection screen 1700 depicted in FIG. 17 is clicked, the display control unit 1403 generates screen information for an application detail input screen for inputting an application amount of the selected agrochemical and transmits the generated screen information to client apparatus 201. As a result, an application detail input screen (e.g., an application detail input screen 1800 depicted in FIG. 18 and described hereinafter) is displayed on the display 406 of the client apparatus 201.

The receiving unit 1401, when the planted crops stored corresponding to the selected fields are the same, receives an agrochemical type and application amount as agrochemical application details for the fields. Input of the agrochemical type and application amount, for example, is performed in the agrochemical selection screen 1700 and the application detail input screen 1800 (described hereinafter and depicted in FIGS. 17 and 18), by a user input operation of the client apparatus 201.

The client apparatus 201 transmits an input result of the input agrochemical type and application amount to the input support apparatus 100. In this case, the receiving unit 1401 receives the input result of the agrochemical and application amount from the client apparatus 201 and thereby, receives the agrochemical type and application amount as agrochemical application details for the fields. The received agrochemical type and application amount, for example, is stored to the work detail table 240 as agrochemical application detail information (e.g., the agrochemical application detail information 800 depicted in FIG. 8).

The calculating unit 1402 distributes the received application amount of the agrochemical for the fields corresponding to the respective areas of the selected fields. Here, when the planting area of the crop under cultivation in the field is large, the application amount of the agrochemical applied to the crop becomes large. Therefore, the calculating unit 1402, for example, refers to the production plan DB 220, and controls the amount of the agrochemical application amount distributed to each field, obtained as a result of proportionately dividing corresponding to the respective planting areas of the planted crop stored associated with each of the selected fields.

For example, as depicted in FIG. 10, “Odawara 1” and “Odawara 2” are assumed to be selected as fields. Further, 150 [L] is assumed to be received as the application amount of the agrochemical “oo granular hydrating agent” applied to the fields “Odawara 1” and “Odawara 2”.

In this case, the calculating unit 1402 distributes the application amount “150 [L]” of the agrochemical “oo granular hydrating agent” to the fields “Odawara 1” and “Odawara 2” corresponding the respective areas. Here, the ratio of the planting areas of the field “Odawara 1” and the field “Odawara 2” is “2 (100 ha):1 (50 ha)”.

Therefore, the calculating unit 1402 distributes the application amount “150 [L]” of the agrochemical “oo granular hydrating agent” to the field “Odawara 1” and the field “Odawara 2” at the ratio of “2:1”. As a result, the field application amount of the agrochemical “oo granular hydrating agent” applied to the field “Odawara 1” is “100 [L]”. The field application amount of the agrochemical “oo granular hydrating agent” applied to the field “Odawara 2” is “50 [L]”.

Thus, corresponding to the respective planting areas of fields in which the agrochemical is applied, the application amount of the agrochemical applied to the fields is proportionately divided according to area.

The distribution result (field application amount) is stored to the work detail table 240 as agrochemical application detail information (e.g., the agrochemical application detail information 800 depicted in FIG. 8). In other words, the application amount of an agrochemical for multiple fields is distributed corresponding the respective areas of the fields and the distributed amounts are recorded as application amounts for each of the fields.

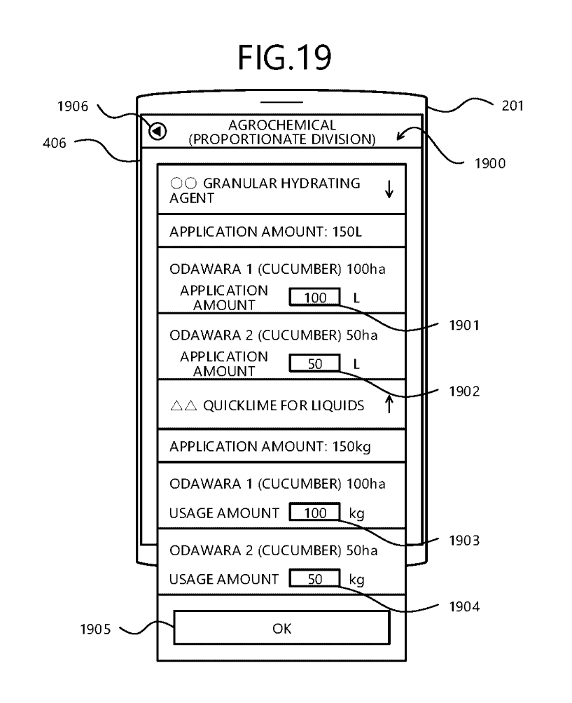

The receiving unit 1401 receives input of a change of an agrochemical application amount distributed to a field. A change of an agrochemical application amount for a field, for example, is performed in a farm-field application detail display screen 1900 (depicted in FIG. 19 and described hereinafter), by a user input operation of the client apparatus 201.

The client apparatus 201 transmits to the input support apparatus 100, a change result for the changed application amount of an agrochemical for a field. In this case, the receiving unit 1401 receives the change result of the application amount of the agrochemical from the client apparatus 201 and thereby, receives a change of an application amount of an agrochemical for a field.

The updating unit 1404 updates the application amount of the agrochemical for the field, based on the received post-change application amount. In particular, for example, the updating unit 1404 updates the corresponding field application amount in the agrochemical application detail information 800 by the received post-change application amount. The updating unit 1404 calculates a total value of the field application amount for each agrochemical. The updating unit 1404 updates the corresponding application amount of the agrochemical in the agrochemical application detail information 800, by the calculated total value of the field application amount of the agrochemical.

When the planted crops in the selected fields are not the same, the display control unit 1403 may refer to the agrochemical master 230 and identify an agrochemical type that may be used commonly on the crops planted in each of the fields. The display control unit 1403 may permit input of agrochemical application details for the identified type with respect to the fields.

For example, agrochemicals for the crop “cucumber” planted in the field “Odawara 1” are assumed to be “agrochemical a”, “agrochemical b”, and “agrochemical c”; and agrochemicals for the crop “tomato” planted in a field “Yokohama 1” are assumed to be “agrochemical b”, “agrochemical c”, and “agrochemical d”.

In this case, the display control unit 1403, for example, may perform control to display on the display 406, an agrochemical selection screen that includes agrochemical b and agrochemical c as selection candidates. As a result, even when the planted crops differ among fields, a work detail can be easily recorded for agrochemical application when an agrochemical is applied that can be commonly used on the planted crops.

When a single field is selected, the display control unit 1403 may permit input of an agrochemical application detail for the selected field. In particular, for example, the display control unit 1403 may control the client apparatus 201 to display on the work recording screen 900 (refer to FIG. 13), an icon for transitioning to an operation screen that receives input of agrochemical application details for the selected field.

An example of a work time screen displaying a work time for each work item in each field will be described. The work time screen, for example, is displayed on the display 406 of the client apparatus 201 when the button 1310 is clicked in the work recording screen 900 (refer to FIG. 13).

FIG. 15 is a diagram depicting an example of a work time screen. In FIG. 15, the work time screen 1500 is an operation screen displaying the work time for each work item in each field. In FIG. 15, among the display contents of the work time screen 1500, a portion not fitting on the screen is virtually displayed.

In the work time screen 1500, the work time for each work item (field rounds, agrochemical application) in each field (Odawara 1, Odawara 2) for each worker (Nakamura, Kato) is displayed.

In particular, in a box 1501, for the work item “field rounds” in the field “Odawara 1”, the work time “2 hours 30 minutes” for the worker “Nakamura” is displayed as a work detail. In a box 1502, for the work item “field rounds” in the field “Odawara 2”, the work time “1 hour 15 minutes” for the worker “Nakamura” is displayed as a work detail.

In a box 1503, for the work item “agrochemical application” in the field “Odawara 1”, the work time “2 hours 30 minutes” for the worker “Nakamura” is displayed as a work detail. In a box 1504, for the work item “agrochemical application” in the field “Odawara 2”, the work time “1 hour 15 minutes” for the worker “Nakamura” is displayed as a work detail.

In a box 1505, for the work item “field rounds” in the field “Odawara 1”, the work time “2 hours 30 minutes” for the worker “Kato” is displayed as a work detail. In a box 1506, for the work item “field rounds” in the field “Odawara 2”, the work time “1 hour 15 minutes” for the worker “Kato” is displayed as a work detail.

In a box 1507, for the work item “agrochemical application” in the field “Odawara 1”, the work time “2 hours 30 minutes” for the worker “Kato” is displayed as a work detail. In a box 1508, for the work item “agrochemical application” in the field “Odawara 2”, the work time “1 hour 15 minutes” for the worker “Kato” is displayed as a work detail.

Thus, a rough work time for each work item in each field may be identified. The rough time is obtained by performing proportionate division corresponding to area, based on the total work time for the farm work in the fields.

In the work time screen 1500, boxes 1501 to 1508 are clicked, thereby enabling a work time for a work item (field rounds, agrochemical application) in a field (Odawara 1, Odawara 2) for a worker (Nakamura, Kato) to be changed. For example, among the workers, one worker may accurately recall the work time of the farm work performed for a work item in a certain field.

In such a case, when a work time displayed in the boxes 1501 to 1508 differs from the actual work time recalled by a worker, the work time for that work item may be changed. For example, for the work item “field rounds” in the field “Odawara 1”, the actual work time for the worker “Nakamura” is assumed to be “2 hours 15 minutes”.

In this case, the box 1501 is clicked, thereby enabling the work time for the worker “Nakamura” to be changed for the work item “field rounds” in the field “Odawara 1”. Thus, a rough time obtained by performing proportionate division corresponding to area, based on the total work time for the farm work may be corrected to the actual work time. In the work time screen 1500, a button 1509 is clicked, thereby enabling input of the work time for each work item (field rounds, agrochemical application) in each field (Odawara 1, Odawara 2) for each worker (Nakamura, Kato) to be set. In the work time screen 1500, a button 1510 is clicked, thereby enabling return to the work recording screen 900 depicted in FIG. 13.

Here, an example of updating the total work time for the farm work will be described taking, as an example, a case where in the work time screen 1500 (refer to FIG. 15), a box 1501 is clicked and for the work item “field rounds” in the field “Odawara 1”, the work time for the worker “Nakamura” is changed from “2 hours 30 minutes” to “2 hours 15 minutes”.

FIG. 16 is a diagram depicting an example of transition of the stored contents of the work detail table 240. In FIG. 16, for the work item “field rounds” in the field “Odawara 1”, the updating unit 1404 updates the work time for the worker “Nakamura” in the work detail table 240 to the post-change work time of “2 hours 15 minutes”.

The updating unit 1404 sums the work times for each work item “field rounds, agrochemical application” for the worker “Nakamura”, “7 hours 15 minutes(=2 hours 15 minutes+2 hours 30 minutes+1 hour 15 minutes+1 hour 15 minutes)”. The updating unit 1404 updates the total work time for the worker “Nakamura” in the work detail table 240 to the calculated total work time “7 hours 15 minutes”. Thus, the total work time for farm work in the fields may be updated according to the actual work times for work items in the fields.

An example of an agrochemical selection screen will be described. An agrochemical selection screen, for example, is displayed on the display 406 of the client apparatus 201 when the icon 1311 is clicked in the work recording screen 900 (refer to FIG. 13).

FIG. 17 is a diagram depicting an example of an agrochemical selection screen. In FIG. 17, the agrochemical selection screen 1700 is an operation screen for selecting an agrochemical applied to the fields. In the agrochemical selection screen 1700, an agrochemical group or a previously selected agrochemical group matching search conditions (e.g., keyword designation) designated by a user input operation may be displayed as selection candidates.

In the agrochemical selection screen 1700, a check box 1701 is clicked, thereby enabling extraction and display of an agrochemical set in cultivation guidelines, the agrochemical being extracted from among agrochemicals applied to the crop “cucumber” planted in the fields “Odawara 1” and “Odawara 2”. The cultivation guidelines, for example, may be identified from the production plan DB 220.

In the agrochemical selection screen 1700, for example, check boxes 1702 to 1704 are clicked, thereby enabling selection of an agrochemical applied to the fields “Odawara 1” and “Odawara 2”. In the example depicted in FIG. 17, the check boxes 1702, 1704 have been clicked, and “oo granular hydrating agent” and “ΔΔ quicklime for liquids” have been selected as agrochemicals applied to the fields “Odawara 1, Odawara 2”.

In the agrochemical selection screen 1700, a button 1705 is clicked, thereby enabling setting of the agrochemical selection. In the agrochemical selection screen 1700, a button 1706 is clicked, thereby enabling selection of all agrochemical selection candidates. In the agrochemical selection screen 1700, a button 1707 is clicked, thereby enabling release of agrochemical selection. In the agrochemical selection screen 1700, a button 1708 is clicked, thereby enabling return to the work recording screen 900 depicted in FIG. 13.

An example of an application detail input screen will be described. An application detail input screen, for example, is displayed on the display 406 of the client apparatus 201 when the button 1705 in the agrochemical selection screen 1700 (refer to FIG. 17) is clicked.

FIG. 18 is a diagram depicting an example of an application detail input screen. In FIG. 18, the application detail input screen 1800 is an operation screen for inputting an application amount of an agrochemical applied to the fields. In the application detail input screen 1800, the agrochemicals “oo granular hydrating agent” and “ΔΔ quicklime for liquids” selected in the agrochemical selection screen 1700 are displayed.

In the application detail input screen 1800, a box 1801 is clicked, thereby enabling input of a dilution factor of the agrochemical “oo granular hydrating agent”. In the application detail input screen 1800, a box 1802 is clicked, thereby enabling input of an application amount of the agrochemical “oo granular hydrating agent”. A box 1803 is clicked, thereby enabling selection of the unit of the application amount of the agrochemical “oo granular hydrating agent”.

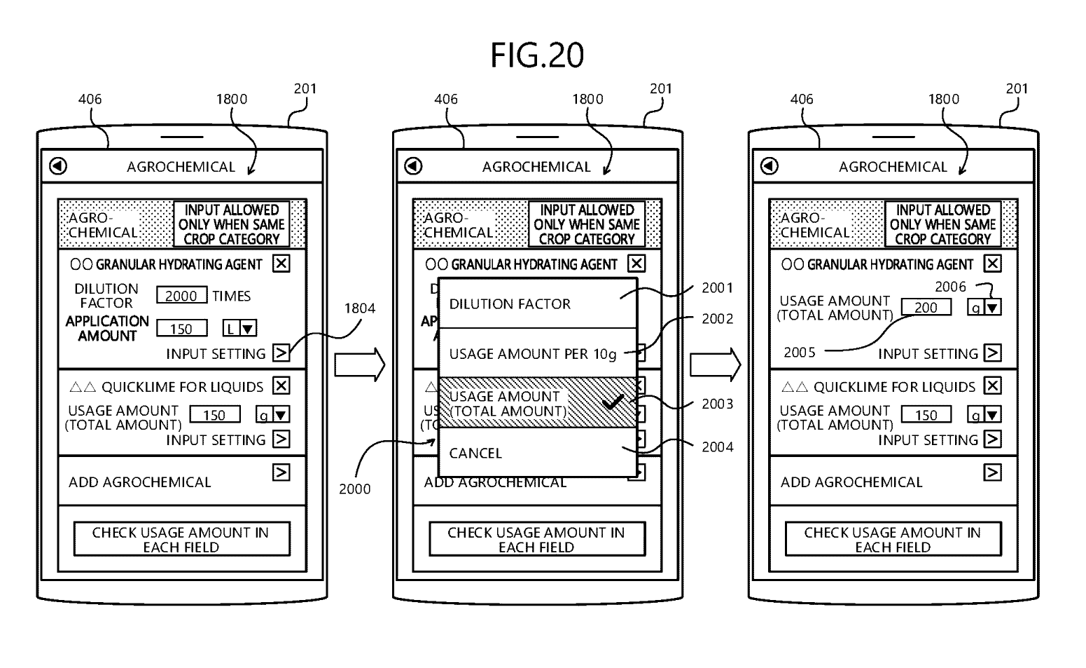

In the application detail input screen 1800, an icon 1804 is clicked, thereby enabling selection of an input method for the application amount of the agrochemical “oo granular hydrating agent”. An example of an input method of the application amount of an agrochemical will be described hereinafter with reference to FIG. 20. In the application detail input screen 1800, an icon 1805 is clicked, thereby enabling release of the selection of the agrochemical “oo granular hydrating agent”.

In the application detail input screen 1800, a box 1806 is clicked, thereby enabling input of an application amount for the agrochemical “ΔΔ quicklime for liquids”. A box 1807 is clicked, thereby enabling selection of the unit of the application amount of the agrochemical “ΔΔ quicklime for liquids”.

In the application detail input screen 1800, an icon 1808 is clicked, thereby enabling selection of an input method for the application amount of the agrochemical “ΔΔ quicklime for liquids”. In the application detail input screen 1800, an icon 1809 is clicked, thereby enabling release of the selection of the agrochemical “ΔΔ quicklime for liquids”.

In the application detail input screen 1800, an icon 1810 is clicked to transition to the agrochemical selection screen 1700 (refer to FIG. 17) and enable addition of an agrochemical applied to the fields. In the application detail input screen 1800, a button 1811 is clicked, thereby enabling transition to a farm-field application detail display screen displaying the application amount (usage amount) of an agrochemical in each field. In the application detail input screen 1800, a button 1812 is clicked to return to the agrochemical selection screen 1700 depicted in FIG. 17. An example of a farm-field application detail display screen will be described hereinafter with reference to FIG. 19.

An example of a farm-field application detail display screen will be described. A farm-field application detail display screen, for example, is displayed on the display 406 of the client apparatus 201 when the button 1811 is clicked in the application detail input screen 1800 (refer to FIG. 18).

FIG. 19 is a diagram depicting an example of a farm-field application detail display screen. In FIG. 19, the farm-field application detail display screen 1900 is an operation screen displaying the application amounts of agrochemicals applied to the respective fields. In FIG. 19, among the display contents of the farm-field application detail display screen 1900, a portion not fitting on the screen is virtually displayed.

In the farm-field application detail display screen 1900, the application amount of an agrochemical for each of the fields (Odawara 1, Odawara 2) is displayed.

In particular, in a box 1901, the application amount “100 [L]” of the agrochemical “oo granular hydrating agent” applied in the field “Odawara 1” is displayed as an application detail. In a box 1902, the application amount “50 [L]” of the agrochemical “oo granular hydrating agent” applied in the field “Odawara 2” is displayed as an application detail.

In a box 1903, the application amount “100 [kg]” of the agrochemical “ΔΔ quicklime for liquids” applied in the field “Odawara 1” is displayed as an application detail. In a box 1904, the application amount “50 [kg]” of the agrochemical “ΔΔ quicklime for liquids” applied in the field “Odawara 2” is displayed as an application detail.

Thus, a rough application amount may be identified for each field, the rough application amount being obtained by proportionately dividing corresponding to area, the application amount of an agrochemical applied in the fields.

In the farm-field application detail display screen 1900, boxes 1901 to 1904 are clicked, thereby enabling an application amount of an agrochemical to be changed for each field (Odawara 1, Odawara 2). For example, a highly experienced worker among the workers may accurately recall the application amount of an agrochemical applied in a certain field.

In such a case, when an application amount displayed in the boxes 1901 to 1904 differs from the application amount recalled by the worker, the application amount of the agrochemical for the field may be changed. For example, the actual application amount of the agrochemical “oo granular hydrating agent” in the field “Odawara 1” is assumed to be “90 [L]”.

In this case, the box 1901 is clicked, thereby enabling the application amount of the agrochemical “oo granular hydrating agent” for the field “Odawara 1” to be changed. Thus, a rough application amount for a field, obtained by proportionately dividing the application amount of an agrochemical applied to the fields may be corrected to the actual application amount.

In the farm-field application detail display screen 1900, a button 1905 is clicked, thereby enabling the application amount of an agrochemical for each field (Odawara 1, Odawara 2) to be set. In the farm-field application detail display screen 1900, a button 1906 is clicked, thereby enabling return to the application detail input screen 1800 depicted in FIG. 18.

When the display contents of the farm-field application detail display screen 1900 do not fit on a single screen, for example, application details for each field related to the next downward agrochemical are displayed by clicking an arrow pointing downward on the screen. Application details for each field related to the next upward agrochemical are displayed by clicking an arrow pointing upward on the screen.

An example of selection of an input method for an application amount of an agrochemical will be described. Here, in the application detail input screen 1800 depicted in FIG. 18, a case where an icon 1804 is clicked will be taken as an example. An example of selecting an input method for an application amount of the agrochemical “oo granular hydrating agent” will be described.

FIG. 20 is a diagram depicting an example of selection of an input method for an application amount of an agrochemical. In the application detail input screen 1800, an icon 1804 is clicked whereby an input method selection screen 2000 is displayed as a pop-up. The input method selection screen 2000 is an operation screen for selecting an input method for an application amount for the agrochemical “oo granular hydrating agent”.

In the input method selection screen 2000, input methods 2001 to 2003 are clicked, thereby enabling selection of an input method for an application amount of the agrochemical “oo granular hydrating agent”. In the input method selection screen 2000, cancel 2004 is clicked, thereby enabling return to the application detail input screen 1800.

In the example depicted in FIG. 20, in the input method selection screen 2000, the input method 2003 has been clicked and an input method “usage amount (total amount)” for the application amount of the agrochemical “oo granular hydrating agent” has been selected. As a result, in the application detail input screen 1800, the input method for the application amount of the agrochemical “oo granular hydrating agent” is changed to “usage amount (total amount)”.

In the application detail input screen 1800, a box 2005 is clicked, thereby enabling input of an application amount of the agrochemical “oo granular hydrating agent” by the input method “usage amount (total amount)”. A box 2006 is clicked, thereby enabling selection of the unit of the application amount of the agrochemical “oo granular hydrating agent”.

A procedure of an input support process of the input support apparatus 100 will be described.

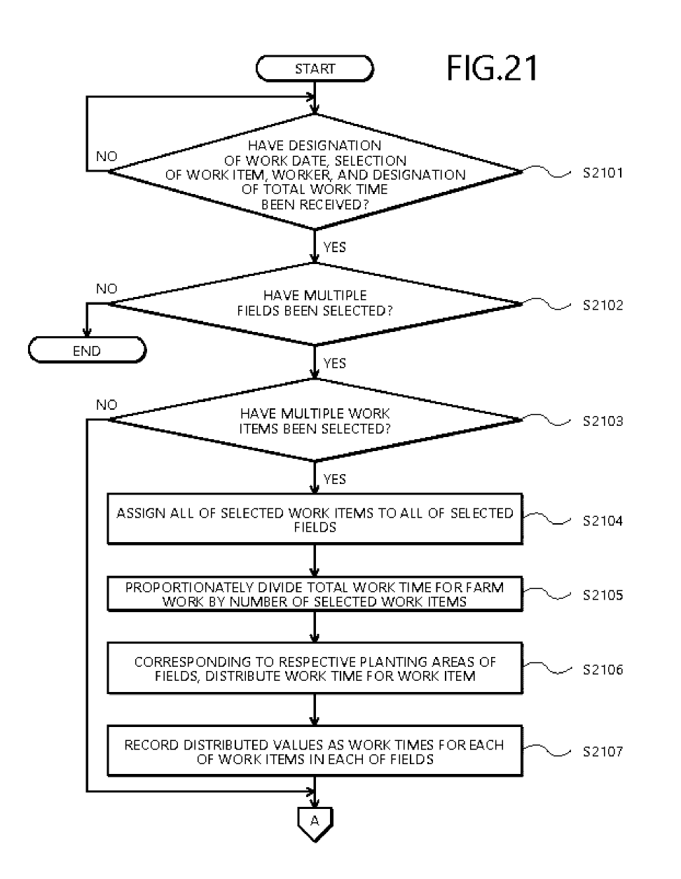

FIGS. 21 and 22 are flowcharts depicting an example of a procedure of an input support process of the input support apparatus 100. In the flowchart depicted in FIG. 21, the input support apparatus 100 determines whether designation of a work date, selection of a work item, a worker, and designation of a total work time have been received (step S2101).

A work date is the work date on which input of the farm work detail is performed. A field is the field for which the farm work detail is input. A work item is the work item for which the farm work detail is input. A worker is the worker for whom the farm work detail is input. The total work time is the total work time for the farm work for which the farm work detail is input.

Here, the input support apparatus 100 stands by for receipt of a work date, field, work item, worker, and total work time (step S2101: NO). When a work date, field, work item, worker, and total work time have been received (step S2101: YES), the input support apparatus 100 determines whether multiple fields have been selected (step S2102).

Here, if multiple fields have not been selected (step S2102: NO), the input support apparatus 100 ends a series of operations according to the present flowchart.

On the other hand, if multiple fields have been selected (step S2102: YES), the input support apparatus 100 determines whether multiple work items have been selected (step S2103). Here, if multiple work items have not been selected (step S2103: NO), the input support apparatus 100 transitions to step S2201 depicted in FIG. 22.

On the other hand, if multiple work items have been selected (step S2103: YES), the input support apparatus 100 assigns all of the selected work items to all of the selected fields (step S2104). The input support apparatus 100 divides the designated total work time for the farm work by the number of selected work items to proportionately divide the total work time (step S2105).

The input support apparatus 100 refers to the production plan DB 220, and corresponding to the planting area of a planted crop stored associated with the respective fields, distributes the work time for each work item, obtained as a result of performing the proportionate division (step S2106). The input support apparatus 100 records the distributed values as the work times for each of the work items in each of the fields (step S2107), and transitions to step S2201 depicted in FIG. 22.

In the flowchart depicted in FIG. 22, the input support apparatus 100 refers to the production plan DB 220 and determines whether the planted crops stored associated with the selected fields are the same (step S2201). If the planted crops are the same (step S2201: YES), the input support apparatus 100 permits input of an agrochemical application detail for the selected fields (step S2202).

The input support apparatus 100 determines whether an agrochemical type and application amount has been received as agrochemical application details for the fields (step S2203) The input support apparatus 100 stands by for receipt of an agrochemical type and application amount (step S2203: NO). When an agrochemical type and application amount have been received (step S2203: YES), the input support apparatus 100 records the received agrochemical type and application amount into the work detail table 240, as agrochemical application detail information (step S2204).

The input support apparatus 100 refers to the production plan DB 220 and corresponding to the planting area of the planted crop stored associated with the selected fields, distributes the received agrochemical application amount (step S2205). The input support apparatus 100 records as agrochemical application detail information in the work detail table 240, the field application amounts obtained by the distribution (step S2206), and ends a series of operations according to the flowchart.

At step S2201, if the planted crops are not the same (step S2201: NO), the input support apparatus 100 restricts input of an agrochemical application detail for the selected fields (step S2207), and ends a series of operations according to the flowchart.

Thus, based on the total work time for the farm work for multiple fields, a rough work time for each work item in each field may be obtained. Further, based on an application amount of an agrochemical applied in multiple fields, a rough application amount for each field may be obtained.

A procedure of a work time updating process of the input support apparatus 100 will be described.

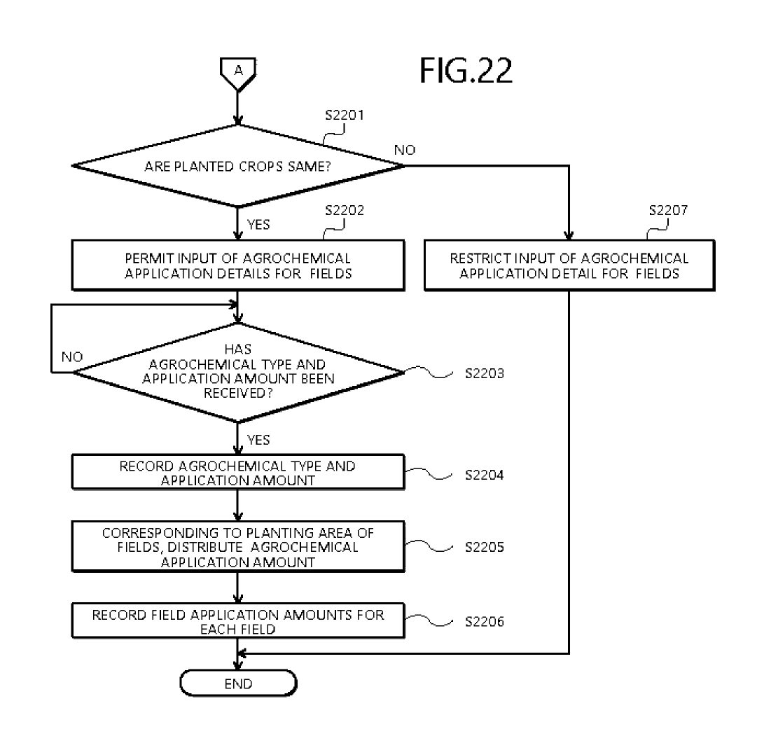

FIG. 23 is a flowchart depicting an example of a procedure of a work time updating process of the input support apparatus 100. In the flowchart depicted in FIG. 23, the input support apparatus 100 determines whether input of a change of a work time for a work item in a field has been received (step S2301). The input support apparatus 100 stands by for receipt of a change of a work time (step S2301: NO).

When a change of a work time has been received (step S2301: YES), the input support apparatus 100 updates in the work detail table 240, the corresponding work time by the received post-change work time (step S2302).

The input support apparatus 100 refers to the work detail table 240 and sums for each worker, the work times for the field•work items (step S2303). The input support apparatus 100 updates the corresponding total work time in the work detail table 240 by the calculated total value of the work times for the field•work items for each worker (step S2304), and ends a series of operations according to the flowchart.

Thus, based on the total work time for the farm work, a rough work time obtained by performing proportionate division corresponding to area may be corrected to the actual work time. Further, the total work time for the farm work may be updated by the actual work times for work items in the fields.

A procedure of an agrochemical application amount updating process of the input support apparatus 100 will be described.

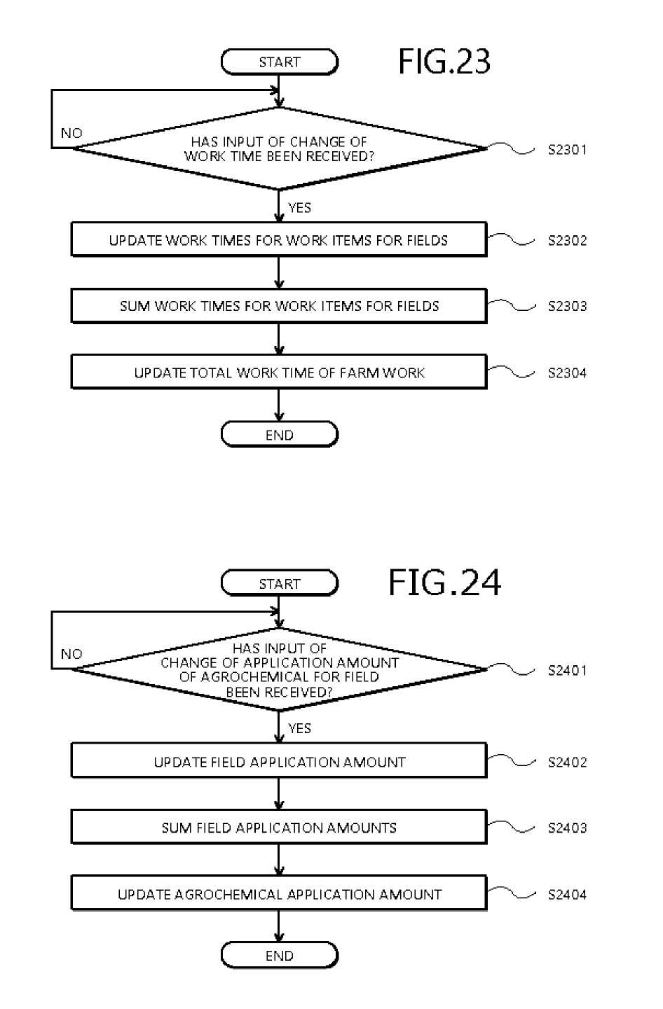

FIG. 24 is a flowchart depicting an example of an agrochemical application amount updating process of the input support apparatus 100. In the flowchart depicted in FIG. 24, the input support apparatus 100 determines whether input of a change of an application amount of an agrochemical has been received for a field (step S2401). The input support apparatus 100 stands by for receipt of input of a change of an application amount (step S2401: NO).

When input of a change of an application amount has been received (step S2401: YES), the input support apparatus 100 updates in the agrochemical application detail information in the work detail table 240, the corresponding field application amount by the received post-change application amount (step S2402).

The input support apparatus 100 refers to the agrochemical application detail information in the work detail table 240 and sums the field application amounts for each agrochemical (step S2403). The input support apparatus 100 updates in the agrochemical application detail information in the work detail table 240, the corresponding agrochemical application amount by the calculated total value of the field application amounts of each agrochemical (step S2404), and ends a series of operations according to the flowchart.

Thus, a rough application amount for each field, obtained by proportionately dividing corresponding to area, the application amount of an agrochemical applied to multiple fields may be corrected to the actual application amount. Further, the application amount of an agrochemical applied to multiple fields may be updated to the actual application amount in each field.

As described, the input support apparatus 100 according to the present embodiment enables selection of a field and work item for which a farm work detail is to be input and designation of the total work time for farm work to be received. When multiple fields and multiple work items are selected, the input support apparatus 100 assigns all of the work items to all of the fields and enables the total work time for the farm work to be distributed to each work item in each field and recorded. Thus, a rough work time for each work item for each field in which farm work was performed may be identified, which may be useful in understanding the state of progress of farm work in each field.

The input support apparatus 100 proportionately divides the total work time for the farm work by the number of work items and enables the work time for each work item, obtained by the proportionate division to be distributed corresponding to the respective areas of the fields. The input support apparatus 100 may record the values obtained by distribution as the work times for work items in the fields. Thus, corresponding to the area of the fields, a rough work time for each work item in each field and may be obtained by proportionately dividing corresponding to area, the work time for each work item, obtained by proportionately dividing the total work time for the farm work by the number of work items.

The input support apparatus 100 receives input of a change of the work time for a work item in a field and enables updating of the total work time for the farm work based on the received post-change work time. Thus, the total work time for farm work for multiple fields may be updated to the actual work time of a work item in the field.

The farm-work-detail input support method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

However, with conventional techniques, collective input of work details for work items in fields in which farm work was performed is a troublesome and burdensome task.

According to one aspect of the present invention, an effect is achieved in that input of work details concerning farm work may be supported.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A farm-work-detail input support method comprising:
receiving, by a computer, selection of a field, selection of a work item, and designation of a total work time; and
recording and distributing, by the computer, the total work time when multiple fields and multiple work items are selected, all the selected work items being assigned to all the selected fields and the total work time being distributed to each work item in each field.

2. The farm-work-detail input support method according to claim 1, wherein
the recording and distributing the total work time includes recording as work times for work items in the fields, values obtained by distributing corresponding to respective areas of the fields, a work time for each work item obtained by proportionately dividing the total work time by a count of the selected work items.

3. The farm-work-detail input support method, according to claim 2, further comprising:
receiving, by the computer, input of a change of the work times for work items in the fields; and
updating, by the computer, the total work time based on the change of the work times for work items in the fields.

4. A non-transitory, computer-readable recording medium storing therein a farm work detail input support program causing a computer to execute a process comprising:
receiving selection of a field, selection of a work item, and designation of a total work time; and
recording and distributing the total work time when multiple fields and multiple work items are selected, all the selected work items being assigned to all the selected fields and the total work time being distributed to each work item in each field.

5. An input support apparatus comprising:
a memory; and
a processor coupled to the memory, the processor configured to:
receive selection of a field, selection of a work item, and designation of a total work time; and
record and distribute the total work time when multiple fields and multiple work items are selected, all the selected work items being assigned to all the selected fields and the total work time being distributed to each work item in each field.
